(19) United States
(12) Patent Application Publication
(10) Pub. No.: US 2014/0298852 A1
(43) Pub. Date: Oct. 9, 2014

(54) BEVERAGE SLEEVE

(71) Applicant: Nova Solutions, LLC, Rochester, NY (US)

(72) Inventors: Michael Rodriguez, Scottsville, NY (US); Harshil Sukhadia, Rochester, NY (US)

(21) Appl. No.: 14/245,090

(22) Filed: Apr. 4, 2014

Related U.S. Application Data
(60) Provisional application No. 61/808,366, filed on Apr. 4, 2013.

(51) Int. Cl. A47J 41/00

(52) U.S. Cl. CPC A47J 41/0055
USPC 62/457.4

(57) ABSTRACT

A beverage sleeve with a phase-change material is provided. When used on a hot beverage, the sleeve facilitates the rapid cooling of the beverage to an acceptable temperature and then maintains the beverage at that temperature for a long period of time. When used on a cold beverage, the sleeve maintains the temperature of the beverage for a long period of time. The phase-change material is provided as an insert placed within a pouch of an outer sleeve. The outer sleeve has a thermally insulating material to help thermally regulate the phase-change material.

### CROSS-REFERENCE TO RELATED APPLICATIONS

This application is a non-provisional of U.S. Patent Application Ser. No. 61/808,366 (filed Apr. 4, 2013) the entirety of which is incorporated herein by reference.

### BACKGROUND OF THE INVENTION

The subject matter disclosed herein relates to packaging for beverage containers.

Many hot beverages are served at a temperature higher than that which would be safe for consumption. In such situations, a user may wait for the beverage to cool to an acceptable temperature before consumption. For example, coffee is often served too hot to immediately consume. Many hot beverages are consumed from disposable paper cups which offer little insulation. Heat from the beverage is lost to the environment and, as a result, an undesirably excessive amount of cooling of the beverage occurs. Similarly, cold beverages have a tendency to warm to an undesirable temperature.

The discussion above is merely provided for general background information and is not intended to be used as an aid in determining the scope of the claimed subject matter.

### BRIEF DESCRIPTION OF THE INVENTION

A beverage sleeve with a phase-change material is provided. When used on a hot beverage, the sleeve facilitates the rapid cooling of the beverage to an acceptable temperature and then maintains the beverage at that temperature for a long period of time. When used on a cold beverage, the sleeve maintains the temperature of the beverage for a long period of time. The phase-change material is provided as an insert placed within a pouch of an outer sleeve. The outer sleeve has a thermally insulating material to help thermally regulate the phase-change material.

In a first embodiment, a beverage sleeve for maintaining a temperature of a beverage is provided. The beverage sleeve comprises an outer sleeve comprising a thermal insulating material. The outer sleeve defines a cylinder with a pouch with the thermal insulating material disposed in the outer layer. The pouch is closed at a bottom end by a seal. An insert is disposed within the pouch, the insert comprising a sealed package enclosing a phase-change material.

In a second embodiment, a beverage sleeve for maintaining a temperature of a beverage is provided. The beverage sleeve comprising an outer sleeve comprising a neoprene thermal insulating material. The outer sleeve defines a cylinder with a pouch with the neoprene thermal insulating material disposed in the outer lay. The pouch is closed at a bottom end by a seal. An insert is disposed within the pouch, the insert comprising a sealed package enclosing a paraffin wax phase-change material have a melting point between about 55° C. and about 70° C. The sealed package of the insert is segmented to provide a plurality of storage areas, the phase-change material being disposed within the plurality of storage areas.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a depiction of an assembly that includes a beverage sleeve;

FIG. 2A and FIG. 2B are perspective views of an outer sleeve of the beverage sleeve of FIG. 1;

FIG. 3A and FIG. 3B are schematic depictions of the outer sleeve of FIG. 2A and FIG. 2B, shown in a flat configuration for simplicity of illustration;

FIG. 4A is a depiction of an insert that has a phase-change material while FIG. 4B is a schematic depiction of the insert disposed within a pouch of the outer sleeve; and

FIG. 5 is a graph depicting thermal performance data for various examples.

### DETAILED DESCRIPTION OF THE INVENTION

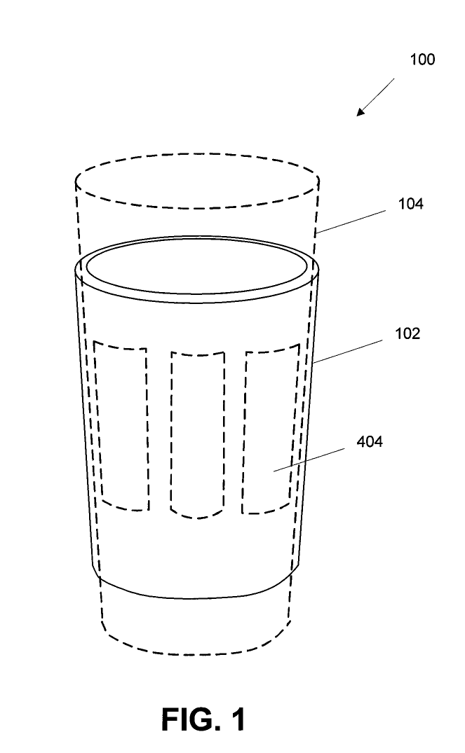

FIG. 1 is a depiction of an assembly 100. The assembly 100 comprises a beverage sleeve 102 wrapped about a container 104. The container 104 may hold a hot beverage (e.g. hot coffee, tea, etc.) or a cold beverage (e.g. iced coffee, ice tea, cold 7971717.4 water, etc.). The beverage sleeve 102 depicted in FIG. 1 comprises a phase-change material 404. The phase-change material 404 permits the beverage sleeve 102 to both (1) cool to an acceptable temperature faster and (2) maintain the beverage at the acceptable temperature for a longer period of time compared to a container that lacks a phase-change material. The phase-change material 404 is a material that changes phase (e.g. solid to liquid or liquid to solid) at certain temperature and absorb or release large amounts of energy in the process—far more than conventional insulation materials.

When used on a hot beverage, the phase-change material 404 absorbs the heat of the beverage and increases in temperature. When the beverage is warmer that the phase-change material, this accelerates cooling of the beverage to an acceptable temperature. When the phase-change material 404 reaches its melting point, a large amount of heat is absorbed without a significant increase in temperature until the phase-change material is completely melted. Should the temperature of the beverage begin to drop, the phase-change material 404 solidifies to release its stored heat and re-warms the beverage. This helps maintain the beverage at a predetermined temperature near the melting point of the phase-change material. A wide variety of phase-change materials with melting points within a useful range for hot beverages (e.g. 65° C. to 85° C.).

A similar effect can be produced for cold beverages by selecting a phase-change material with a different melting point (e.g. 0° C. to 15° C.). Phase-change materials for use in cold beverages may be stored in a cold environment (e.g. freezer or refrigerator) prior to use.

Examples of suitable phase-change materials are provided in Table 1. The selected phase-change material generally has a melting point between 0° C. and 100° C. and a latent heat between 100 J per gram and 400 J per gram. In another embodiment, the melting point is between 50° C. and 70° C. and a latent heat of fusion between 150 J per gram and 250 J per gram. In yet another embodiment, the melting point is between 58° C. and 62° C. and a latent heat of fusion between 200 J per gram and 220 J per gram. Thickeners may be added to adjust the viscosity of the phase-change material when in its liquid state. Colorants may be added to customize the appearance.

TABLE 1
Examples of suitable phase change materials

| Phase-change material | Melting Point: | | Intended use |
|---|---|---|---|
| Paraffin Wax | 37° C.-80° | C. | Hot Beverage |
| Stearic Acid | 69.8° | C. | Hot Beverage |
| Palmitic Acid | 62.9° | C. | Hot Beverage |
| Water | 0° | C. | Cold Beverage |

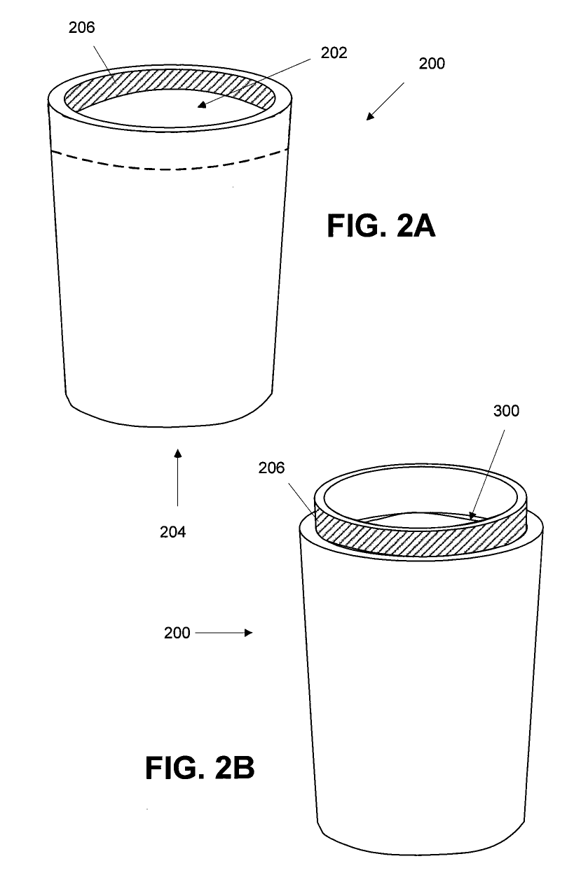

FIG. 2A and FIG. 2B are perspective views of an outer sleeve 200 of the beverage sleeve 102 of FIG. 1. The outer sleeve 200 is comprised of a thermal insulating material. Examples of suitable thermal insulating materials include synthetic and natural rubbers, polyesters, batting, heat reflective substances, expanded foams, neoprene, etc. In one embodiment, the thermal insulating material is selected to render the outer sleeve 200 flexible. The outer sleeve 200 is generally cylindrical and provides a top opening 202 and a bottom opening 204 for receiving the container 104. In one embodiment, the diameter of the top opening 202 is slightly larger than the diameter of the bottom opening 204 such that the outer sleeve 200 is tapered to secure attach to the container 104 without sliding off The top opening 202 comprises a flap 206 that seals a pouch 300. In FIG. 2A, the flap 206 is folded down to cover the opening of the pouch 300, thereby securing its contents. In FIG. 2B, the flap 206 is folded up to reveal the opening of the pouch 300, thereby permitting access to its contents.

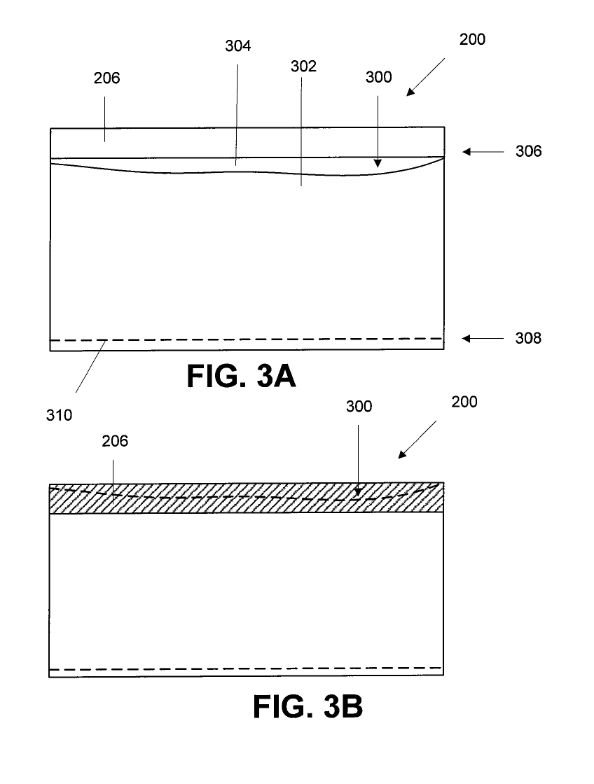

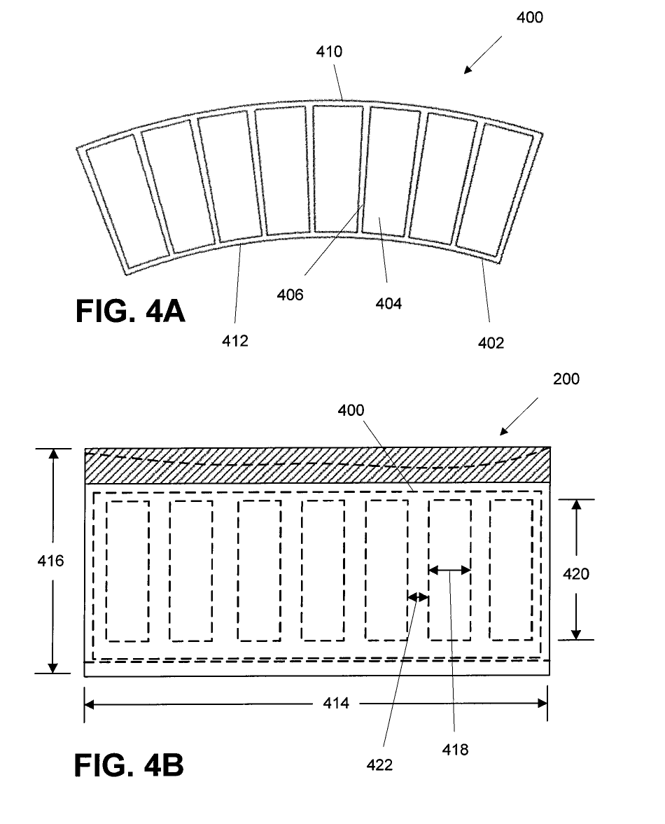

FIG. 3A and FIG. 3B are schematic depictions of the outer sleeve 200. For illustrative purposes, the outer sleeve 200 is shown in a flat configuration from the viewpoint of the inside of the outer sleeve 200. FIG. 3A depicts the flap 206 folded up to reveal the opening of the pouch 300. FIG. 3B depicts the flap 206 folded down over a top end 306 of the outer sleeve 200 to cover the opening to pouch 300. The pouch 300 is closed at a bottom end 308 of the outer sleeve 200 by a seal 310. The seal 310 may be, for example, a sewn seam or a thermally sealed closure. The pouch 300 is defined by an inner layer 302 and an outer layer 304, at least one of which comprises the thermal insulating material. In one embodiment, the outer layer 304 comprises the thermal insulating material while the inner layer 302 is formed of a flexible material that is less thermally insulating. In another embodiment, both the outer layer 304 and the inner layer 302 comprise the thermal insulating material. The pouch 300 is configured to receive an insert 400, shown in FIG. 4A.

FIG. 4A is a depiction of an insert 400. The insert 402 comprises a sealed package 402 enclosing the phase-change material 404. In one embodiment, the sealed package 402 is segmented to provide a plurality of storage areas 406. Each storage area is isolated from adjacent storage areas by a seal 408 which, in one embodiment, is formed by thermally sealing the sealed package 402. Other suitable sealing means may also be used including, but not limited to, adhesives, ultrasonic welding, etc. The sealed package 402 may be formed from a material that is conducive to the formation of the seals 408. Examples of suitable materials include polymers, metalized polymers, metal films, and the like. In one embodiment, the seal package 402 is formed from paraffin wax. Each storage area 406 encloses the phase-change material 404. The sealed package 402 comprises a long edge 410 and a short edge 412 which, when formed into a cylinder, provides a tapered configured that matches the tapered configuration of the outer sleeve 200.

FIG. 4B is a schematic depiction of the insert 400 disposed within the pouch 300 of the outer sleeve 200. The outer sleeve 200 has a length 414 and a height 416. Each storage area 406 of the insert 400 has a width 418 and a height 420 and is separated from adjacent storage area(s) by a space 422. A sufficient number of storage areas 406 with the width 418 are provided to cover at least 60% of the length 414. In one embodiment, at least 80% of the length 414 is covered by the width 418 of all of the storage areas 406. The height 420 of the storage area 406 covers at least 60% of the height 416 of the outer sleeve 200. In one embodiment, at least 80% of the height 416 is covered by the height 420 of each storage area 406. The height 416 of the outer sleeve 200 is selected to cover a significant portion of the container 104 and thereby provide good thermal contact with the storage areas 406 and the phase change material 404 disposed therein. In one embodiment, multiple storage areas are provided to permit the insert 400 to flex along the seals 408. This permits the insert 400 to be fit around a container even when the phase-change material 404 is in a solid state. Additionally, the use of multiple storage areas provides a failsafe: should one storage area be punctured the remaining storage areas will still function.

The removeably of the insert 400 from the pouch 300 provides numerous advantages. First, a variety of inserts may be provided, each with a difficult melting point. For example, a hot insert and a cold insert may be provided and the user selected the appropriate insert for use with the outer sleeve 200 depending on the type of beverage being consumed. Additionally, the cold insert may be stored in a refrigerator or freezer for later use while the hot insert is being used.

### EXAMPLES

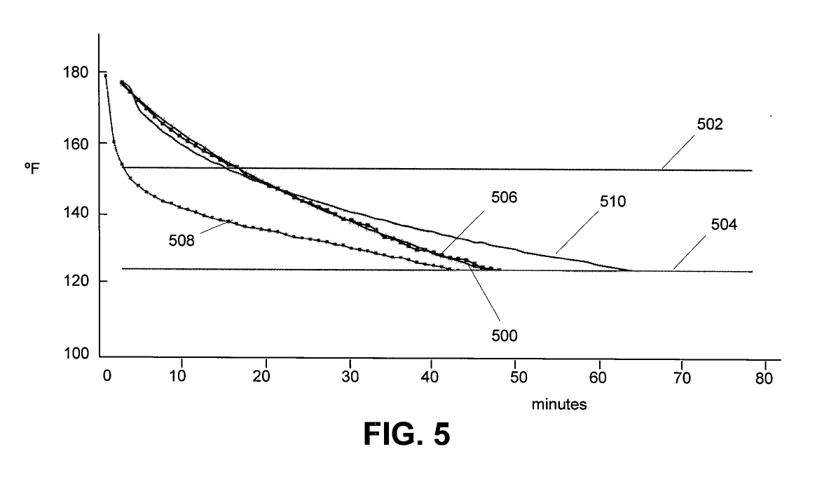

FIG. 5 is a graph depicting the drop in temperature as a function of time for various hot beverages.

Control: A 12 oz sample of water was heated to 180° F. in a paper cup. A thermocouple was used to record the temperature at 1 minute intervals and the cup remained covered under ambient conditions (about 22° C.). The data is presented as line 500 in FIG. 5. The control cooled to an acceptably low temperature (155° F., denoted by line 502) after 16 minutes but dropped below an acceptably hot temperature (125° F., denoted by line 504) after only 46 minutes.

### Comparative Example 1

A 12 oz sample of water was heated to 180° F. in a paper cup. The cup was enclosed with a competing beverage insulator, formed of a simple neoprene sleeve, sold under the brand name JOE JACKET®. A thermocouple was used to record the temperature at 1 minute intervals and the cup remained uncovered under ambient conditions (about 22° C.). The data is presented as line 506 in FIG. 5. The sample cooled to an acceptably low temperature (155° F.) after 16 minutes but dropped below an acceptably hot temperature (125° F.) after only 47 minutes. Despite the addition of the competitor's beverage insulator, no significant performance difference was detected relative to the control.

### Comparative Example 2

A 12 oz sample of water was heated to 180° F. in a paper cup. A thermocouple was used to record the temperature at 1 minute intervals and the cup remained covered under ambient conditions (about 22° C.). A phase-change material sealed within a stainless steel shell, sold under the brand name COFFEE JOULIES™, was added to the cup. The data is presented as line 508 in FIG. 5. The sample cooled to an acceptably low temperature (155° F.) after only 3 minutes but dropped below an acceptably hot temperature (125° F.) after only 44 minutes. The addition of phase-change material inside of the cup did not maintain the longevity of the beverage relative to the control.

### Example

A 12 oz sample of water was heated to 180° F. in a paper. The cup was enclosed with a beverage sleeve made in accordance with the teachings of this specification (outer layer formed from neoprene, phase change material was paraffin wax with a melting point of 62° C.). A thermocouple was used to record the temperature at 1 minute intervals and the cup remained uncovered under ambient conditions (about 22° C.). The data is presented a line 510 in FIG. 5. The sample cooled to an acceptably low temperature (155° F.) after 14 minutes (two minutes faster than the control) but dropped below an acceptably hot temperature (125° F.) until 64 minutes (18 minutes longer than the control; 17 minutes longer than comparative example 1 and 20 minutes longer than comparative example 2).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A beverage sleeve for maintaining a temperature of a beverage, the beverage sleeve comprising:
an outer sleeve comprising a thermal insulating material, the outer sleeve defining a cylinder with a top opening and a bottom opening, the outer sleeve comprising a pouch defined by an inner layer and an outer layer of the outer sleeve, wherein the thermal insulating material is disposed in the outer layer and the pouch is closed at a bottom end by a seal;
an insert disposed within the pouch, the insert comprising a sealed package enclosing a phase-change material.

2. The beverage sleeve as recited in claim 1, further comprising a flap configured to fold over a top end of the outer sleeve and thereby close the pouch.

3. The beverage sleeve as recited in claim 2, the flap being permanently attached to the outer layer and configured to fold over the top end to contact the inner layer.

4. The beverage sleeve as recited in claim 1, wherein the sealed package of the insert is segmented to provide a plurality of storage areas, the phase-change material being disposed within the plurality of storage areas.

5. The beverage sleeve as recited in claim 1, wherein the thermal insulating material is a polymeric insulating material.

6. The beverage sleeve as recited in claim 1, wherein the thermal insulating material is neoprene.

7. The beverage sleeve as recited in claim 1, wherein the top opening has a first diameter and the bottom opening has a second diameter, the second diameter being less than the first diameter to provide a tapered configuration to the outer sleeve.

8. The beverage sleeve as recited in claim 1, wherein the phase-change material is selected to have a melting point between 0° C. and 10° C.

9. The beverage sleeve a recited in claim 8, wherein the phase-change material is water.

10. The beverage sleeve as recited in claim 1, wherein the phase-change material is selected to have a melting point between 50° C. and 70° C.

11. The beverage sleeve a recited in claim 10, wherein the phase-change material is selected from the group consisting of paraffin wax, stearic acid and palmitic acid.

12. The beverage sleeve as recited in claim 1, wherein the insert is removeably disposed within the pouch.

13. The beverage sleeve a recited in claim 1, wherein the insert is closed within the pouch by a fastener disposed at an opening of the pouch.

14. A beverage sleeve for maintaining a temperature of a beverage, the beverage sleeve comprising:
an outer sleeve comprising a neoprene thermal insulating material, the outer sleeve defining a cylinder with a top opening and a bottom opening, the outer sleeve comprising a pouch defined by an inner layer and an outer layer of the outer sleeve, wherein the thermal insulating material is disposed in the outer layer and the pouch is closed at a bottom end by a seal;
an insert disposed within the pouch, the insert comprising a sealed package enclosing a paraffin wax phase-change material have a melting point between about 55° C. and about 70° C., wherein the sealed package of the insert is segmented to provide a plurality of storage areas, the phase-change material being disposed within the plurality of storage areas.

15. The beverage sleeve as recited in claim 14, wherein the thermal insulating material is neoprene and the phase-change material is paraffin wax with a melting point of about 62° C.

16. The beverage sleeve as recited in claim 14, further comprising a flap configured to fold over a top end of the outer sleeve and thereby close the pouch.

17. The beverage sleeve as recited in claim 14, the flap being permanently attached to the outer layer and configured to fold over the top end to contact the inner layer.
